(19) United States
(12) Patent Application Publication
(10) Pub. No.: US 2014/0020961 A1
(43) Pub. Date: Jan. 23, 2014

(54) PORTABLE ELECTRONIC DEVICE HAVING WEIGHING FUNCTION AND ELECTRONIC WEIGHING SYSTEM USING SAME

(71) Applicants: FIH (Hong Kong) Limited, Kowloon (HK); SHENZHEN FUTAIHONG PRECISION INDUSTRY CO., LTD., Shenzhen (CN)

(72) Inventors: GUO-MIN LUO, Shenzhen (CN); YING YANG, Shenzhen (CN)

(21) Appl. No.: 13/925,918

(22) Filed: Jun. 25, 2013

(30) Foreign Application Priority Data
Jul. 23, 2012 (CN) 2012102551052

(51) Int. Cl. G01G 19/414

(52) U.S. Cl. CPC G01G 19/414
USPC 177/25.15; 177/25.14

(57) ABSTRACT

A portable electronic device includes a housing, a pressure sensor, a signal processing module, an analog-to-digital converting module, a processor, and a setting keypad. The housing supports an object to be weighed. The pressure sensor is mounted on the housing and outputs an analog voltage signal that varies with a pressure exerted on the pressure sensor. The signal processing module amplifies and filters the analog voltage signal. The analog-to-digital converting module converts the analog voltage signal into a digital signal. The processor calculates a weight exerted on the pressure sensor according to the digital signal and calibrates the weight of the pressure sensor when the setting keypad is activated.

### BACKGROUND

1. Technical Field

The exemplary disclosure generally relates to scales, and particularly to a portable electronic device having a weighing function and an electronic weighing system using same.

2. Description of Related Art

A weighing scale is a measuring instrument used for determining a weight or mass of an object. Weighing scales are used in many industrial and commercial applications. However, industrial scales are not very portable and so are not very convenient to use.

Therefore, there is room for improvement within the art.

### BRIEF DESCRIPTION OF THE DRAWINGS

Many aspects of the embodiments can be better understood with reference to the drawings. The components in the drawings are not necessarily drawn to scale, the emphasis instead being placed upon clearly illustrating the principles of the disclosure.

FIG. 1 shows an isometric view of an exemplary embodiment of a portable electronic device having a weighing function.

FIG. 2 shows an isometric view of an electronic weighing system using the portable electronic device shown in FIG. 1.

FIG. 3 shows a block diagram of the portable electronic device shown in FIG. 1.

### DETAILED DESCRIPTION

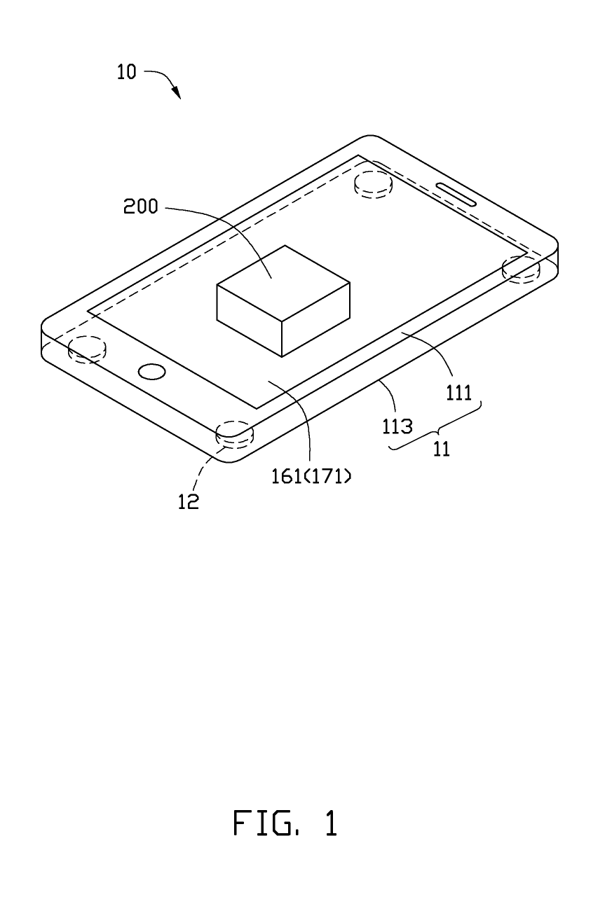

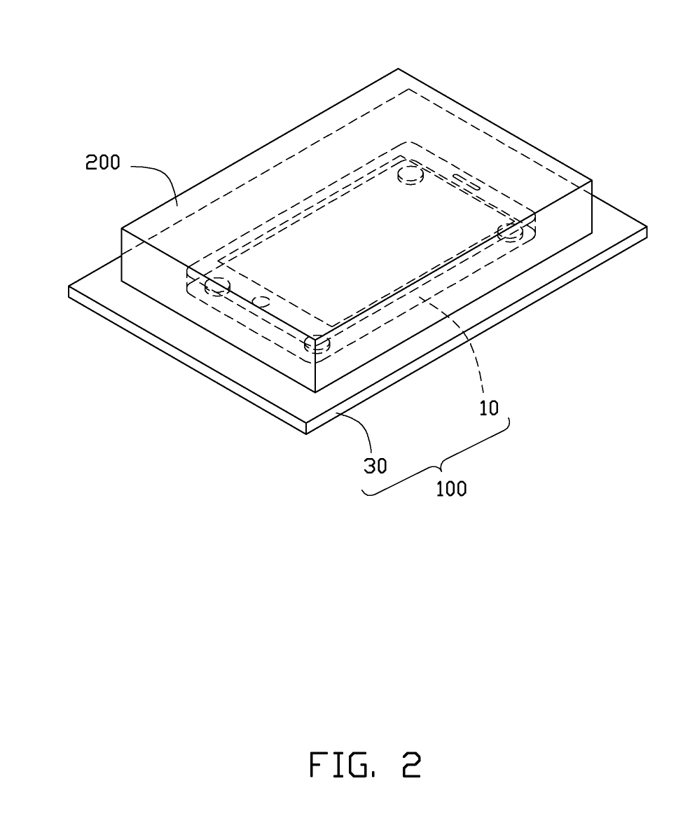

FIG. 1 shows an isometric view of an exemplary embodiment of a portable electronic device 10 having a weighing function. FIG. 2 shows an isometric view of an electronic weighing system 100 using the portable electronic device 10 shown in FIG. 1. The electronic weighing system 100 includes the portable electronic device 10 and a supporting board 30.

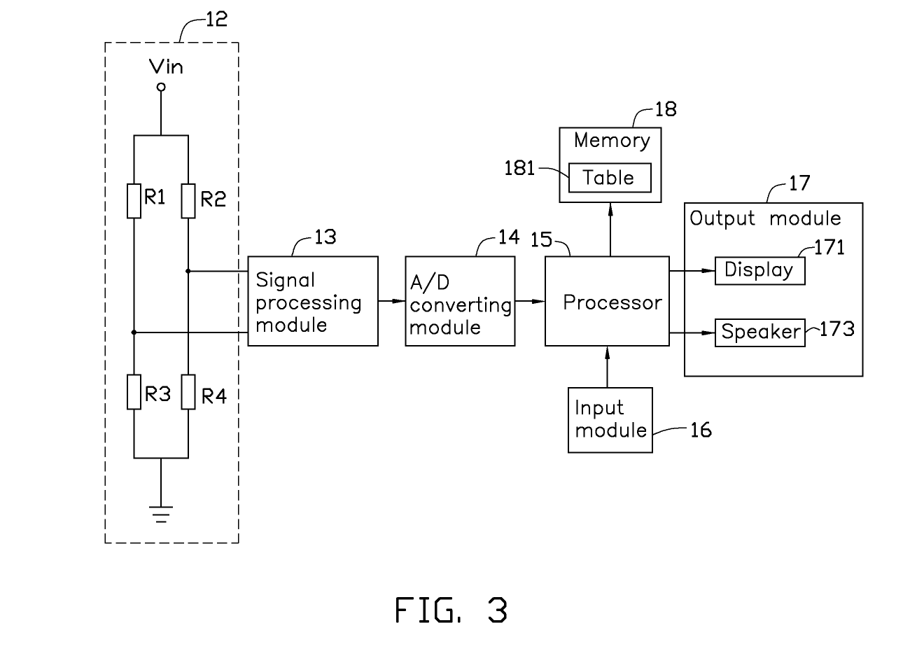

FIG. 3 shows a block diagram of the portable electronic device 10 shown in FIG. 1. The portable electronic device 10 can be a mobile phone, a personal digital assistant, or a tablet computer, for example. The portable electronic device 10 includes a housing 11, a pressure sensor 12, a signal processing module 13, an analog-to-digital (A/D) converting module 14, a processor 15, an input module 16, an output module 17, and a memory 18.

The housing 11 includes a first surface 111 and an opposite second surface 113. When the portable electronic device 10 measures the weight of an object 200, the first surface 111 either supports the supporting board 30 or the object 200 directly. The supporting board 30 is especially used if the object 200 has a large volume or large mass.

An area of a bottom surface of the supporting board 30 is greater than an area of the first surface 111.

The pressure sensor 12 outputs an analog voltage signal according to a pressure exerted on the pressure sensor 12. The pressure sensor 12 is attached to the second surface 113 and supports the housing 11. The pressure sensor 12 includes at least one strain gauges; in this embodiment there are four, one placed at each corner of the second surface 113. When the pressure sensor 12 is pressed, the strain gauges deform, causing their resistance to change.

The four strain gauges are denoted as resistors R1-R4 (see FIG. 3). The resistors R1-R4 cooperate to form a bridge circuit, and an excitation voltage Vin is input to the bridge circuit. When none of the strain gauges R1-R4 are pressed, an output voltage of the bridge circuit is about zero. When the strain gauges R1-R4 are pressed, the bridge circuit outputs the analog voltage that varies with the pressure exerted on the pressure sensor 12.

The signal processing module 13 filters and amplifies the analog voltage signal. The A/D converting module 14 converts the analog voltage signal into a digital signal and outputs the digital signal to the processor 15.

The processor 15 calculates a weight value exerted on the pressure sensor 12. Since the portable electronic device 10 itself has a tare weight, the processor 10 calibrates the pressure sensor 12 to the weight of the electronic device 10 before the object 200 is supported on the portable electronic device 10. Similarly, if the supporting board 30 is used, the processor 10 calibrates the pressure sensor 12 to the weight of the supporting board 30 and the electronic device 10. When the object 200 is supported on the portable electronic device 10, the processor 10 calculates a weight of the object 200 according to the digital signal, and stores the weight of the object 200 in the memory 18. In the exemplary embodiment, the processor 15 executes the calculation of the weight of the object 200 after the object 200 is supported on the portable electronic device 10 over a first predetermined time period, such as two seconds.

The input module 16 includes a touch panel 161 (shown in FIG. 1) and a setting keypad. The setting keypad can either be a physical keypad or a virtual keypad. The touch panel 161 is mounted on the first surface 111 of the housing 11 and is electronically connected to the processor 15. The processor 15 calibrates the pressure sensor 12 when the setting keypad is activated. In the exemplary embodiment, the setting keypad is a virtual keypad activated by the touch panel 161. In another embodiment, the processor 15 calibrates the pressure sensor 12 after the setting keypad is activated over a second predetermined time period, such as five seconds. Because the supporting board 30 covers the touch panel 161, the setting keypad is first pressed, and the supporting board 30 is placed on the first surface 111 within five seconds of pressing the setting keypad so that the processor 15 calibrates the pressure sensor 12 to the weight of the electronic device 10 and the supporting board 30.

The output module 17 includes a display 171 and a speaker 173, both of which are mounted on the housing 11. The display 171 displays the weight of the object 200 and the setting keypad. The weight value displayed on the display 171 is reset when the setting keypad is activated. The speaker 173 executes a countdown of the predetermined time period after the setting keypad is activated.

The memory 18 stores a table 181. The table 181 stores a plurality of types of information, such as the name of the object 200, the weight of the object 200, the unit-price of the object 200, the total price of the weighted object 200, the first predetermined time period, and the second predetermined time period. When the table 181 is displayed on the display 171, a user can use the touch panel 161 to edit the table 181. For example, a user can edit first predetermined time period or the second predetermined time period . Thus, a portable scale for weighing objects is achieved.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A portable electronic device, comprising:
a housing configured to support an object;
a pressure sensor mounted on the housing and supporting the housing, the pressure sensor outputting an analog voltage signal that varies with a pressure exerted on the pressure sensor;
a signal processing module amplifying and filtering the analog voltage signal;
an analog-to-digital converting module converting the analog voltage signal into a digital signal;
a processor calculating a weight exerted on the pressure sensor according to the digital signal; and
a setting keypad electronically connected to the processor, wherein the processor calibrates the weight of the pressure sensor when the setting keypad is activated.

2. The portable electronic device of claim 1, wherein the processor calibrates the pressure sensor to a weight of the electronic device.

3. The portable electronic device of claim 1, wherein the processor calibrates the weight exerted on the pressure sensor after the setting keypad is activated over a predetermined setting time.

4. The portable electronic device of claim 1, wherein the housing comprises a first surface and a second surface, the first surface supports the object; the pressure sensor is mounted onto the second surface.

5. The portable electronic device of claim 1, wherein the pressure sensor comprises four strain gauges that cooperate to form a bridge circuit, an output of the bridge circuit is electronically connected to the signal processing module.

6. The portable electronic device of claim 1, wherein the setting keypad is one of a physical keypad and a virtual keypad activated by operating on a touch panel.

7. The portable electronic device of claim 1, further comprising a memory, wherein the memory stores a table, the table comprises information of a name of the object, the weight of the object, a unit-price of the object, and a total price of a weighed object.

8. An electronic scale system, comprising:
a supporting board configured to support an object; and
a portable electronic device; comprising:
a housing supporting the supporting board;
a pressure sensor mounted on the housing and supporting the housing, the pressure sensor outputting an analog voltage signal that varies with a pressure exerted on the pressure sensor;
a signal processing module amplifying and filtering the analog voltage signal;
an analog-to-digital converting module converting the analog voltage signal into a digital signal;
a processor calculating a weight exerted on the pressure sensor according to the digital signal; and
a setting keypad electronically connected to the processor, wherein the processor calibrates the weight of the pressure sensor when the setting keypad is activated.

9. The electronic scale system of claim 8, wherein the processor the processor calibrates the pressure sensor to a weight of the supporting board and the electronic device.

10. The electronic scale system of claim 8, wherein the processor calibrates the weight exerted on the pressure sensor after the setting keypad is activated over a predetermined setting time.

11. The electronic scale system of claim 8, wherein the housing comprises a first surface and a second surface, the first surface supports the supporting board; the pressure sensor is mounted onto the second surface.

12. The electronic scale system of claim 8, wherein the pressure sensor comprises four strain gauges that cooperate to form a bridge circuit, an output of the bridge circuit is electronically connected to the signal processing module.

13. The electronic scale system of claim 8, wherein the setting keypad is one of a physical keypad and a virtual keypad activated by operating on a touch panel.

14. The electronic scale system of claim 8, further comprising a memory, wherein the memory stores a table, the table comprises information of a name of the object, the weight of the object, a unit-price of the object, and a total price of the weighed object.
